(19) United States
(12) Patent Application Publication
(10) Pub. No.: US 2024/0278398 A1
(43) Pub. Date: Aug. 22, 2024

(54) ELECTRIC TOOL, CONTROL METHOD, AND PROGRAM

(71) Applicant: Panasonic Holdings Corporation, Osaka (JP)

(72) Inventor: Akito NAKAMURA, Mie (JP)

(21) Appl. No.: 18/570,020

(22) PCT Filed: Mar. 7, 2022
(86) PCT No.: PCT/JP2022/009734

§ 371 Date: Dec. 13, 2023

(30) Foreign Application Priority Data
Jul. 8, 2021 (JP) 2021-113699

(51) Int. Cl. B25B 23/142

(52) U.S. Cl. CPC B25B 23/1425

(57) ABSTRACT

An electric tool includes a motor, a driving controller, an output shaft, a transmission mechanism, and a seating detector. The driving controller controls the motor. The output shaft is to be coupled to a tip tool for use to fasten a fastening member. The seating detector detects seating of the fastening member. The driving controller controls the motor to make a number of revolutions of the motor at a point in time of the seating equal to a predetermined number of revolutions associated with a torque setting. The driving controller changes a value of a motive power to be supplied to the motor into a predetermined value or less in response to detection of the seating by the seating detector.

### TECHNICAL FIELD

The present disclosure generally relates to an electric tool, a control method, and a program, and more particularly relates to an electric tool including a motor, a method for controlling the electric tool, and a program.

### BACKGROUND ART

Patent Literature 1 discloses an electric fastening machine including an electric motor, a flywheel directly coupled to the electric motor, a drive shaft to which a socket is attached, and a clutch for transmitting the rotational force of the flywheel to the drive shaft. The electric fastening machine of Patent Literature 1 transmits the rotational energy stored in advance in the flywheel to the drive shaft by connecting the clutch instantaneously.

### CITATION LIST

### Patent Literature

Patent Literature 1: JP S62-277272 A

### SUMMARY OF INVENTION

The electric fastening machine (electric tool) of Patent Literature 1 cuts off the electric motor current upon connecting the clutch. After having connected the clutch, the electric fastening machine fastens a bolt and nut (fastening member) with the rotational energy stored in advance in the flywheel. Thus, in the electric fastening machine of Patent Literature 1, in the interval between a point in time when the bolt and nut (fastening member) has started to be fastened and a point in time when the fastening member is seated, the rotational energy stored in advance in the flywheel is consumed, thus preventing the fastening torque of the fastening member from reaching a torque setting, which is a problem with the electric fastening machine of Patent Literature 1.

In view of the foregoing background, it is therefore an object of the present disclosure to provide an electric tool, a control method, and a program, all contributing to improving the accuracy of the fastening torque.

An electric tool according to an aspect of the present disclosure includes a motor, a driving controller, an output shaft, a transmission mechanism, and a seating detector. The driving controller controls the motor. The output shaft is to be coupled to a tip tool for use to fasten a fastening member. The transmission mechanism is interposed between the motor and the output shaft and transmits rotational force of the motor to the output shaft. The seating detector detects seating of the fastening member. The driving controller controls the motor to make a number of revolutions of the motor at a point in time of the seating equal to a predetermined number of revolutions associated with a torque setting. The driving controller changes a value of a motive power to be supplied to the motor into a predetermined value or less in response to detection of the seating by the seating detector.

A control method according to another aspect of the present disclosure is designed to be used in an electric tool for fastening a fastening member by using a motor as a power source. The control method includes a detection step, a first control step, and a second control step. The detection step includes detecting seating of the fastening member. The first control step includes controlling the motor to make a number of revolutions of the motor at a point in time of the seating equal to a predetermined number of revolutions associated with a torque setting. The second control step includes changing a value of a motive power to be supplied to the motor into a predetermined value or less in response to detection of the seating in the detection step.

A program according to still another aspect of the present disclosure is designed to cause one or more processors to perform the control method described above.

### BRIEF DESCRIPTION OF DRAWINGS

FIG. 1 is a block diagram of an electric tool according to an exemplary embodiment;

FIG. 2 is a schematic representation of the electric tool;

FIGS. 3A-3C illustrate how the electric tool performs a fastening operation;

FIG. 4 shows a graph representing a current to be supplied to a motor in the electric tool;

FIG. 5 is a flowchart showing how the electric tool operates; and

FIG. 6 shows a graph representing a current to be supplied to the motor in an electric tool according to a variation.

### DESCRIPTION OF EMBODIMENTS

A preferred embodiment of the present disclosure will now be described in detail with reference to the accompanying drawings. In the following description of embodiments, any pair of constituent elements having the same function will be designated by the same reference numeral and description thereof will be omitted herein to avoid redundancy. Note that the embodiment to be described below is only an exemplary one of various embodiments of the present disclosure and should not be construed as limiting. Rather, the exemplary embodiment may be readily modified in various manners depending on a design choice or any other factor without departing from the scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio. It should also be noted that the arrows indicating respective directions on the drawings are only examples and should not be construed as defining the directions in which the electric tool 1 is supposed to be used. In addition, those arrows indicating the respective directions on the drawings are shown there only for the purpose of description and are insubstantial ones.

### (1) Overview

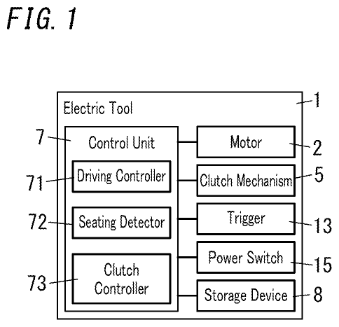

First, an overview of an electric tool 1 according to an exemplary embodiment will be described with reference to FIGS. 1-4.

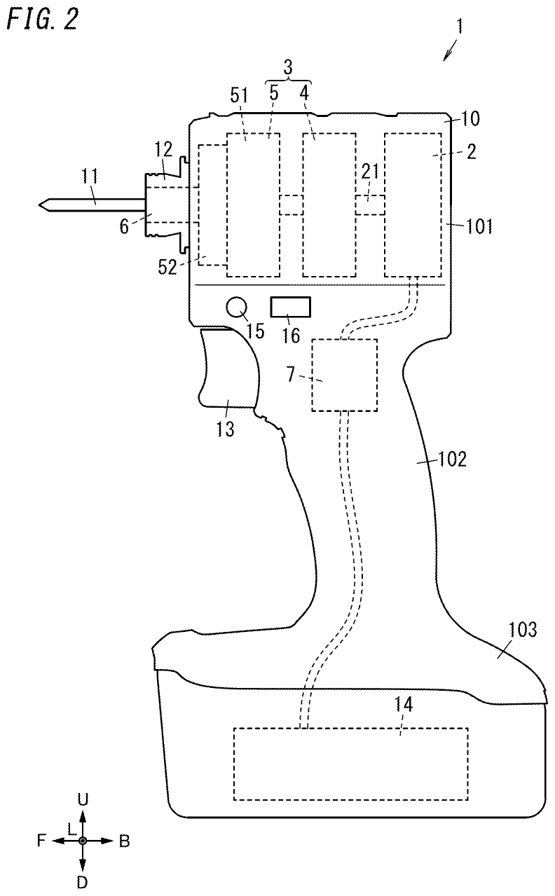

As shown in FIG. 1, the electric tool 1 according to this embodiment includes a motor 2, a driving controller 71, an output shaft 6 (refer to FIG. 2), a transmission mechanism 3 (refer to FIG. 2), and a seating detector 72.

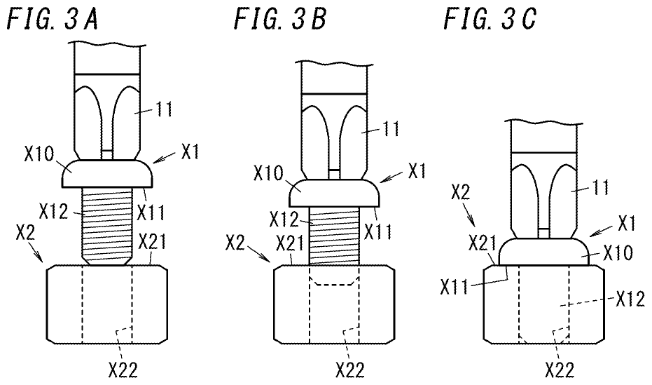

The driving controller 71 controls the motor 2. The output shaft 6 is to be coupled to a tip tool 11 such as a screwdriver bit for fastening a fastening member X1 (refer to FIG. 3) such as a screw or a bolt. The transmission mechanism 3 is interposed between the motor 2 and the output shaft 6. The transmission mechanism 3 transmits the rotational force of the motor 2 to the output shaft 6. The seating detector 72 detects seating of the fastening member X1.

As used herein, “seating of a fastening member” may refer to a situation where the fastening member X1 has been fastened to a predetermined degree or more into a mate member X2 such as a wall material or a nut. In addition, “seating of fastening member” as used herein may also refer to a situation where when the fastening member X1 is fastened into the mate member X2, the fastening torque to fasten the fastening member X1 increases to a prescribed value or more within a predetermined amount of time. In this embodiment, “seating of a fastening member” refer to bringing a facing surface X11 of the head X10 of the fastening member X1 into contact with a surface X21 (facing surface) of the mate member X2 as shown in FIG. 3C. Note that in the following description, the electric tool's 1 operation of fastening the fastening member X1 into the mate member X2 will be hereinafter sometimes referred to as a “fastening operation.”

The driving controller 71 according to this embodiment controls the motor 2 to make the number of revolutions of the motor 2 at a point in time of seating of the fastening member X1 equal to a predetermined number of revolutions associated with a torque setting. In addition, the driving controller 71 changes a value of a motive power to be supplied to the motor 2 into a predetermined value or less in response to detection of the seating of the fastening member X1 by the seating detector 72. As used herein, the “motive power” refers to a form of motive power to be supplied to the motor 2 and is a power for activating the motor 2. The “motive power” may include, for example, at least one of electric current, voltage, or electric power.

The electric tool 1 according to this embodiment controls the number of revolutions of the motor 2 at a point in time of seating of the fastening member X1, thus improving the accuracy of the fastening torque irrespective of the length of the fastening member X1, for example. In addition, the electric tool 1 also changes the value of the motive power to be supplied to the motor 2 into a predetermined value or less in response to seating of the fastening member X1, thus reducing the chances of causing a kickback.

### (2) Configuration for Electric Tool

Next, a detailed configuration for the electric tool 1 according to this embodiment will be described with reference to FIGS. 1-4. As shown in FIG. 2, the directions aligned with the output shaft 6 will be defined to be forward/backward directions in the following description. Specifically, the direction pointing from the motor 2 toward the output shaft 6 will be hereinafter referred to as a “forward direction” and the direction pointing from the output shaft 6 toward the motor 2 will be hereinafter referred to as a “backward direction.” Also, in the following description, the directions perpendicular to the forward/backward directions on the paper on which FIG. 2 is drawn will be defined to be “upward/downward directions.” Specifically, the direction pointing from a grip 102 (to be described later) toward a barrel 101 (to be described later) will be hereinafter referred to as an “upward direction” and the direction pointing from the barrel 101 toward the grip 102 will be hereinafter referred to as a “downward direction.” Furthermore, in the following description, directions perpendicular to the forward, backward, upward, and downward directions will be hereinafter referred to as “rightward/leftward directions.” In this embodiment, on the paper on which FIG. 2 is drawn, the direction pointing from the paper toward the viewer is herein defined to be the “leftward direction” and the direction pointing away from the viewer toward the paper is herein defined to be the “rightward direction.”

The electric tool 1 is a portable electric tool which may be gripped by the worker with one of his or her hands. The electric tool 1 includes a housing 10, the motor 2, the transmission mechanism 3, the output shaft 6, a control unit 7, a storage device 8 (refer to FIG. 1), a chuck 12, a trigger 13, a power switch 15, and a forward/reverse switch 16.

The housing 10 includes the barrel 101, the grip 102, and an attachment 103. The barrel 101 is formed in the shape of a cylinder, of which the rear end is bottomed. The barrel 101 houses the motor 2 and the transmission mechanism 3 therein. The grip 102 protrudes downward from the barrel 101. The grip 102 houses the control unit 7 therein. The attachment 103 is provided at the tip (i.e., bottom) of the grip 102. In other words, the barrel 101 and the attachment 103 are coupled together via the grip 102. To the attachment 103, a battery pack 14 is attached removably.

A rechargeable battery pack 14 is attached removably to the electric tool 1. The electric tool 1 according to this embodiment is powered by the battery pack 14 as a power supply. That is to say, the battery pack 14 is a power supply that supplies a current for driving the motor 2. In this embodiment, the battery pack 14 is not a constituent element of the electric tool 1. However, this is only an example and should not be construed as limiting. Alternatively, the electric tool 1 may include the battery pack 14 as a constituent element thereof. The battery pack 14 includes an assembled battery formed by connecting a plurality of secondary batteries (such as lithium-ion batteries) in series and a case that houses the assembled battery therein.

The motor 2 is a power source for the electric tool 1. The motor 2 may be a brushless motor, for example. In particular, the motor 2 according to this embodiment is a synchronous motor. More specifically, the motor 2 may be a permanent magnet synchronous motor (PMSM). The motor 2 includes: a rotor with a permanent magnet; and a stator with armature windings for three phases (namely, U-, V-, and W-phases). The rotor has a motor shaft 21. The motor 2 transforms the electric power supplied from the battery pack 14 into the rotational force of the motor shaft 21.

The transmission mechanism 3 is interposed between the motor 2 and the output shaft 6. Specifically, the transmission mechanism 3 is disposed forward of the motor 2 and backward of the output shaft 6. The motor shaft 21 of the motor 2 and the output shaft 6 are mechanically connected to the transmission mechanism 3. The transmission mechanism 3 transmits the rotational force of the motor shaft 21 to the output shaft 6.

The transmission mechanism 3 according to this embodiment includes an inertial body 4 and a clutch mechanism 5.

The inertial body 4 is interposed between the clutch mechanism 5 and the motor 2. Specifically, the inertial body 4 is disposed forward of the motor 2 and backward of the clutch mechanism 5. The inertial body 4 is mechanically connected to the motor shaft 21 and rotates integrally with the motor shaft 21. The inertial body 4 is a so-called “flywheel” and increases the inertial force of the rotational force of the motor 2 (motor shaft 21).

The clutch mechanism 5 is interposed between the output shaft 6 and the inertial body 4. Specifically, the clutch mechanism 5 is disposed forward of the inertial body 4 and backward of the output shaft 6. The clutch mechanism 5 switches from a first state to a second state, or vice versa. The first state herein refers to a state where rotational force is transmitted from the motor 2 to the output shaft 6. The second state herein refers to a state where no rotational force is transmitted from the motor 2 to the output shaft 6.

The clutch mechanism 5 includes a first transmission unit 51 and a second transmission unit 52. The first transmission unit 51 is mechanically connected to the motor shaft 21 of the motor 2. The second transmission unit 52 is mechanically connected to the output shaft 6. The first transmission unit 51 and the second transmission unit 52 are connected to each other to be ready to be disconnected from each other. When the clutch mechanism 5 is in the first state, the first transmission unit 51 and the second transmission unit 52 are mechanically connected to each other and integrated together. That is to say, while the clutch mechanism 5 is in the first state, as the first transmission unit 51 rotates, the second transmission unit 52 also rotates accordingly. When the clutch mechanism 5 is in the second state, the first transmission unit 51 and the second transmission unit 52 are separated from each other (i.e., disconnected from each other). That is to say, while the clutch mechanism 5 is in the second state, the second transmission unit 52 does not rotate even if the first transmission unit 51 rotates.

The tip (front end) of the output shaft 6 is provided with the chuck 12. To the chuck 12, a tip tool 11 such as a screwdriver bit or a socket may be attached removably. As the output shaft 6 turns, the tip tool 11 attached to the chuck 12 also turns accordingly. If a screwdriver bit as the tip tool 11 is attached to the chuck 12 as shown in FIG. 2, then the work of tightening or loosening the fastening member X1 may be performed by rotating the tip tool 11 set in place on the fastening member X1 (refer to FIG. 3A).

The trigger 13 protrudes forward from the grip 102. The trigger 13 is an operating unit that accepts an operating command entered by the worker. By pulling the trigger 13, the worker may change the state of the clutch mechanism 5. That is to say, the worker may change, by pulling the trigger 13, the state of the clutch mechanism 5 from the first state where the first transmission unit 51 and the second transmission unit 52 are connected to each other to the second state where the first transmission unit 51 and the second transmission unit 52 are disconnected from each other, or vice versa.

The power switch 15 protrudes leftward from the grip 102. The motor 2 is driven by pressing the power switch 15 with the battery pack 14 attached to the electric tool 1.

The forward/reverse switch 16 also protrudes leftward from the grip 102. The forward/reverse switch 16 is a switch for changing the rotational direction of the motor shaft 21 of the motor 2 from the forward direction to the reverse direction, and vice versa. In other words, the forward/reverse switch 16 is switch for changing the rotational direction of the output shaft 6 from the forward direction to the reverse direction, or vice versa.

The control unit 7 includes a computer system including one or more processors and a memory. At least some functions of the control unit 7 are performed by making the processor of the computer system execute a program stored in the memory of the computer system. The program may be stored in the memory. Alternatively, the program may also be downloaded via a telecommunications line such as the Internet or distributed after having been stored in a non-transitory storage medium such as a memory card.

As shown in FIG. 1, the control unit 7 according to this embodiment includes the driving controller 71, the seating detector 72, and a clutch controller 73.

The driving controller 71 control the motor 2. The driving controller 71 may control the motor 2 by vector control, for example. The driving controller 71 breaks down a motor current, i.e., a current to be supplied to the motor 2, into a torque current (q-axis current) that generates torque and an excitation current (d-axis current) that generates a magnetic flux and controls these current components independently of each other. Note that the driving controller 71 does not have to control the motor 2 by vector control. Alternatively, the driving controller 71 may also control the motor 2 by a different control method from the vector control.

The driving controller 71 controls the motor 2 to make the fastening torque of the fastening member X1 equal to a torque setting (work setting). Specifically, the driving controller 71 controls the motor 2 to make the number of revolutions of the motor 2 at a point in time of the seating of the fastening member X1 equal to a predetermined number of revolutions associated with the torque setting. As used herein, the “point in time of seating of the fastening member X1” may refer to a period from a point in time immediately before the fastening member X1 is seated through a point in time when the fastening member X1 has just been seated. Note that the torque setting may be set by, for example, making the worker perform a predetermined operation on the operating panel of the electric tool 1.

Also, as used herein, the “predetermined number of revolutions associated with the torque setting” refers to the number of revolutions that has been preset in association with the torque setting. For example, the higher the torque setting is, the higher the predetermined number of revolutions is. In this embodiment, number of revolutions information that associates a plurality of torque settings and a plurality of predetermined numbers of revolutions one to one is stored in the storage device 8. When a torque setting is set by the worker, for example, the driving controller 71 according to this embodiment checks the number of revolutions information stored in the storage device 8 to acquire information about a predetermined number of revolutions associated with the torque setting. Then, the driving controller 71 controls the motor 2 to make the number of revolutions of the motor 2 at a point in time of the seating of the fastening member X1 equal to a predetermined number of revolutions associated with the torque setting.

In addition, as described above, the driving controller 71 changes a value of a motive power to be supplied to the motor 2 into a predetermined value or less in response to detection of seating of the fastening member X1 (refer to FIG. 3C) by the seating detector 72. In this embodiment, in response to detection of seating of the fastening member X1 by the seating detector 72, the driving controller 71 changes a value of the motor current (torque current) to be supplied to the motor 2 into a predetermined value or less. Note that the predetermined value is stored in advance in the storage device 8 and may be, for example, 0 A. The driving controller 71 according to this embodiment cuts off, in response to detection of seating of the fastening member X1 by the seating detector 72, the motor current to be supplied to the motor 2. Cutting off, in response to seating of the fastening member X1, the motor current to be supplied to the motor 2 may further reduce the chances of causing a kickback, which is one of the advantages of this embodiment.

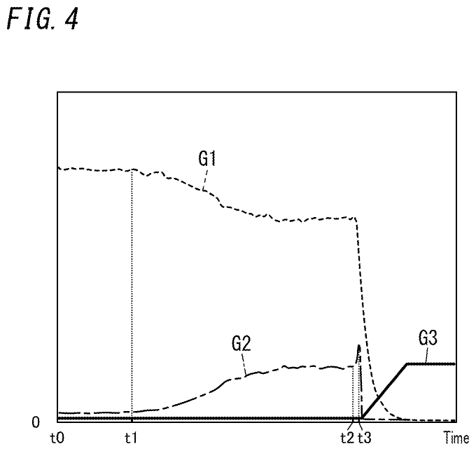

The seating detector 72 detects seating of the fastening member X1. The seating detector 72 according to this embodiment detects seating of the fastening member X1 by monitoring the motor current (torque current) to be supplied to the motor 2. Next, it will be described with reference to FIG. 4 how the seating detector 72 operates.

FIG. 4 shows a graph representing the motor current in the electric tool 1. In FIG. 4, the graph G1 shows how the number of revolutions of the motor 2 (indicated by the ordinate) changes with time (indicated by the abscissa). The graph G2 shows how the motor current (torque current) (indicated by the ordinate) changes with time (indicated by the abscissa). Note that as the seating detector 72 according to this embodiment monitors the torque current, the graph G2 may be regarded as a graph showing how the torque (load) applied to the output shaft 6 (motor shaft 21) changes with time. The graph G3 shows how the fastening torque of the fastening member X1 (indicated by the ordinate) changes with time (indicated by the abscissa).

At a point in time t0, the motor 2 is being driven and the motor shaft 21 is turning. At the point in time t0, the driving controller 71 controls the motor 2 to make the number of revolutions of the motor 2 at the point in time (i.e., point in time t2) of seating of the fastening member X1 equal to a predetermined number of revolutions. At the point in time t0, the state of the clutch mechanism 5 is a second state. Driving the motor 2 to increase its number of revolutions while the state of the clutch mechanism 5 is the second state enables shortening the time it takes for the electric tool 1 to finish its fastening operation since the electric tool 1 has started performing the fastening operation, which is one of the advantages of this embodiment.

When the trigger 13 is pulled by the worker at a point in time t1, the electric tool 1 starts performing the fastening operation. More specifically, when the trigger 13 is pulled by the worker, the state of the clutch mechanism 5 (refer to FIG. 2) changes from the second state into the first state. That is to say, a transition is made into the state where the first transmission unit 51 and the second transmission unit 52 are connected to each other and the clutch mechanism 5 transmits the rotational force of the motor shaft 21 to the output shaft 6.

At the point in time t1, the fastening member X1 may have, for example, the state shown in FIG. 3A. At this point in time t1, the thread X12 of the fastening member X1 is not fitted yet into the thread X22 of a mate member X2 such as a nut.

After the point in time t1, at least part of the thread X12 of the fastening member X1 has been fitted into the thread X22 of the mate member X2 as shown in FIG. 3B. As shown in FIG. 4, as the thread X12 of the fastening member X1 is fitted to an increasing degree into the thread X22 of the mate member X2, the torque applied to the output shaft 6 increases accordingly.

Meanwhile, when the state of the clutch mechanism 5 changes from the second state into the first state at the point in time t1, the rotational velocity (number of revolutions) of the motor 2 decreases. In this case, the electric tool 1 according to this embodiment includes the inertial body 4 interposed between the first transmission unit 51 of the clutch mechanism 5 and the motor 2, and therefore, may reduce the chances of causing a decrease in the number of revolutions of the motor 2. This enables, even if the fastening member X1 is very short, for example, bringing the number of revolutions of the motor 2 that has once decreased when the transition is made from the second state into the first state closer to a predetermined number of revolutions by the time when the fastening member X1 is seated.

At a point in time t2, the facing surface X11 of the head X10 of the fastening member X1 comes into contact with the surface X21 (facing surface) of the mate member X2 to make the fastening member X1 seated as shown in FIG. 3C. When the fastening member X1 is seated, the torque applied to the output shaft 6 increases steeply as shown in FIG. 4. The seating detector 72 according to this embodiment detects the seating of the fastening member X1 when finding that the value of the motor current has increased to a prescribed degree or more within a predetermined amount of time. In the example shown in FIG. 4, at a point in time t3, the seating detector 72 detects the seating of the fastening member X1. As soon as the seating of the fastening member X1 is detected by the seating detector 72 at the point in time t3, the driving controller 71 cuts off the current (motor current) to be supplied to the motor 2. As indicated by the graph G3, after the point in time t3, the fastening member X1 is fastened by, for example, the kinetic energy that the inertial body 4 rotating has, thus bringing the fastening torque of the fastening member X1 closer to the torque setting.

The clutch controller 73 shown in FIG. 1 performs the control of changing the state of the clutch mechanism 5 between the first state and the second state in accordance with the operating command entered through the trigger 13 (operating unit). When the trigger 13 is pulled by the worker, the clutch controller 73 performs the control of changing the state of the clutch mechanism 5 from the second state to the first state. Providing the electric tool 1 according to this embodiment with the clutch controller 73 allows the state of the clutch mechanism 5 to be changed between the first and second states in accordance with the operating command entered by the worker, which is one of the advantages of this embodiment.

The storage device 8 may be, for example, an electrically erasable programmable read-only memory (EEPROM). The storage device 8 may be a memory of the control unit 7. The storage device 8 according to this embodiment stores the number of revolutions information described above.

### (3) Operation of Electric Tool

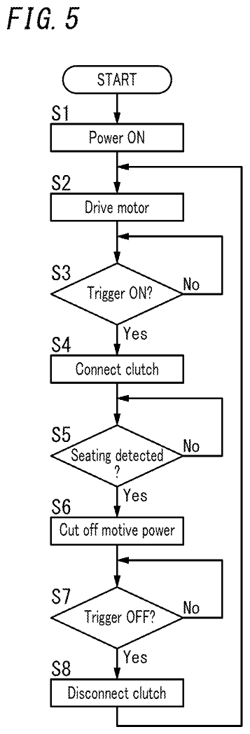

Next, it will be described with reference to FIG. 5 how the electric tool 1 according to this embodiment operates. FIG. 5 is a flowchart showing how the electric tool 1 operates.

When the electric tool 1 is powered ON by turning the power switch 15 of the electric tool 1 (in S1), the driving controller 71 supplies an electric current (which is a motive power) to the motor 2, thereby driving the motor 2 (in S2). In this case, the driving controller 71 controls the motor 2 to make the number of revolutions of the motor 2 at a point in time of seating of the fastening member X1 equal to a predetermined number of revolutions associated with a torque setting. Note that at the point in time of Step S2, the clutch mechanism 5 is in the second state and the tip tool 11 is not rotating yet. At this point in time, the worker sets the tip tool 11 in place on the fastening member X1.

The clutch controller 73 determines whether the trigger 13 has been pulled by the worker (i.e., whether the trigger 13 has been turned ON) (in S3). If the clutch controller 73 decides that the trigger 13 have not been pulled yet (if the answer is NO in S3), the clutch controller 73 performs the processing step S3 repeatedly until the trigger 13 is pulled. On the other hand, if the clutch controller 73 decides that the trigger 13 have been pulled (if the answer is YES in S3), the clutch controller 73 performs control of connecting the first transmission unit 51 and the second transmission unit 52 to each other to connect the clutch mechanism 5 (in S4). The control by the clutch controller 73 changes the state of the clutch mechanism 5 from the second state to the first state. Changing the state of the clutch mechanism 5 from the second state to the first state causes the rotational force of the motor 2 to be transmitted to the tip tool 11, thus turning the tip tool 11. In addition, changing the state of the clutch mechanism 5 from the second state to the first state causes decrease in the rotational velocity (number of revolutions) of the motor 2. The driving controller 71 controls the motor 2 to make the number of revolutions of the motor 2 at a point in time of seating of the fastening member X1 equal to a predetermined number of revolutions associated with a torque setting.

The seating detector 72 determines whether the fastening member X1 has been seated yet (in S5). If the seating detector 72 decides that the fastening member X1 have not been seated yet (i.e., if the seating detector 72 has not detected seating of the fastening member X1) (if the answer is NO in S5), then the driving controller 71 performs this processing step S5 repeatedly until the seating detector 72 detects the seating of the fastening member X1. On the other hand, if the seating detector 72 decides that the fastening member X1 have been seated (i.e., if the seating detector 72 has detected seating of the fastening member X1) (if the answer is YES in S5), then the driving controller 71 cuts off the current (which is a motive power) to be supplied to the motor 2 (in S6). In other words, the driving controller 71 changes the value of the motive power to be supplied to the motor 2 into a predetermined value or less. After the motor 2 has stopped being driven, the fastening member X1 is fastened by the kinetic energy that the inertial body 4 rotating has, for example.

The clutch controller 73 determines whether the trigger 13 has been released by the worker (i.e., whether the trigger 13 has been turned OFF) (in S7). If the clutch controller 73 decides that the trigger 13 have not been released yet (i.e., if the answer is NO in S7), then the clutch controller 73 performs this processing step S7 repeatedly until the trigger 13 is released. On the other hand, if the clutch controller 73 decides that the trigger 13 have been released (if the answer is YES in S7), then the clutch controller 73 performs the control of disconnecting the first transmission unit 51 and the second transmission unit 52 from each other to disconnect the clutch mechanism 5 (in S8). The control by the clutch controller 73 changes the state of the clutch mechanism 5 from the first state to the second state. Then, the electric tool 1 resumes performing the processing step S2.

### (4) Variations

Next, variations of the exemplary embodiment will be enumerated one after another. Note that the variations to be described below may be adopted in combination as appropriate.

The functions equivalent to those of the electric tool 1 according to the exemplary embodiment described above may also be implemented as, for example, a control method, a (computer) program, or a non-transitory storage medium that stores the program thereon. A control method according to an aspect is designed to be used in an electric tool 1 for fastening a fastening member X1 by using a motor 2 as a power source. The control method includes a detection step, a first control step, and a second control step. The detection step includes detecting seating of the fastening member X1. The first control step includes controlling the motor 2 to make the number of revolutions of the motor 2 at a point in time of the seating equal to a predetermined number of revolutions associated with a torque setting. The second control step includes changing a value of a motive power to be supplied to the motor 2 into a predetermined value or less in response to detection of the seating in the detection step. A program according to another aspect is designed to cause one or more processors to perform the control method described above.

The electric tool 1 according to the present disclosure includes a computer system in its control unit 7. The computer system may include a processor and a memory as principal hardware components thereof. The functions of the control unit 7 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

The electric tool 1 only needs to include at least the motor 2, the driving controller 71, the output shaft 6, the transmission mechanism 3, and the seating detector 72.

To the electric tool 1, a socket may be attached as the tip tool 11 instead of the screwdriver bit. Furthermore, the electric tool 1 does not have to be configured to use the battery pack 14 as its power supply but may also be configured to use an AC power supply (commercial power supply) as its power supply.

Optionally, the electric tool 1 may include a torque sensor for measuring the fastening torque. The torque sensor may be, for example, a magnetostrictive strain sensor with the ability to detect torsional strain. The magnetostrictive strain sensor detects a variation in permeability to be caused by the strain produced upon the application of torque to the output shaft 6 and outputs a voltage signal proportional to the strain. If the electric tool 1 includes a torque sensor, the seating detector 72 may detect, based on the fastening torque detected by the torque sensor, the seating of the fastening member X1.

The driving controller 71 may change, in response to detection of the seating of the fastening member X1 by the seating detector 72, the value of the power to be supplied to the motor 2 into a predetermined value or less. In addition, the driving controller 71 may also change, in response to the detection of the seating of the fastening member X1 by the seating detector 72, the value of the voltage to be applied to the motor 2 into a predetermined value or less. Making the driving controller 71 change the value of the power to be supplied, or the voltage to be applied, to the motor 2 into a predetermined value or less in response to the seating of the fastening member X1 enables reducing the chances of causing a kickback, which is one of the advantages of this embodiment.

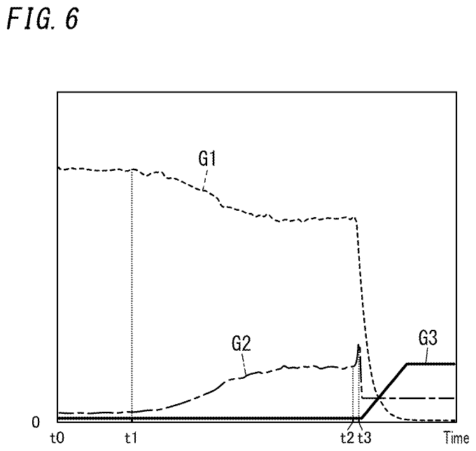

In the exemplary embodiment described above, the driving controller 71 is supposed to change, in response to the seating of the fastening member X1, the motive power (e.g., the electric current) to be supplied to the motor 2 into a predetermined value or less by cutting off the supply of the motive power. However, the driving controller 71 does not have to cut off the supply of the motive power in response to the seating of the fastening member X1. Alternatively, the driving controller 71 may make, in response to detection of seating of the fastening member X1 by the seating detector 72, the value of the motive power to be supplied to the motor 2 equal to or less than the value of the motive power when the fastening member X1 is seated as shown in FIG. 6. In the example shown in FIG. 6, at the point in time t2 when the fastening member X1 is seated, the motor current may have a value of 30 A, for example. From the point in time t3 when the seating detector 72 detects the seating of the fastening member X1 and on, the driving controller 71 may set the value of the motive power to be supplied to the motor 2 at 10 A, for example. In this manner, the driving controller 71 makes, in response to the seating of the fastening member X1, the value of the motive power to be supplied to the motor 2 equal to or less than the value of the motive power at the point in time of the seating. This enables reducing the chances of causing a kickback, which is one of the advantages of this embodiment.

### (Recapitulation)

As can be seen from the foregoing description, an electric tool (1) according to a first aspect includes a motor (2), a driving controller (71), an output shaft (6), a transmission mechanism (3), and a seating detector (72). The driving controller (71) controls the motor (2). The output shaft (6) is to be coupled to a tip tool (11) for use to fasten a fastening member (X1). The transmission mechanism (3) is interposed between the motor (2) and the output shaft (6) and transmits rotational force of the motor (2) to the output shaft (6). The seating detector (72) detects seating of the fastening member (X1). The driving controller (71) controls the motor (2) to make a number of revolutions of the motor (2) at a point in time of the seating equal to a predetermined number of revolutions associated with a torque setting. The driving controller (71) changes a value of a motive power to be supplied to the motor (2) into a predetermined value or less in response to detection of the seating by the seating detector (72).

According to this aspect, the number of revolutions of the motor (2) at a point in time of seating of the fastening member (X1) is controlled, thus improving the accuracy of the fastening torque irrespective of the length of the fastening member (X1), for example. In addition, the value of a motive power to be supplied to the motor (2) is changed into a predetermined value or less in response to seating of the fastening member (X1), thus reducing the chances of causing a kickback.

In an electric tool (1) according to a second aspect, which may be implemented in conjunction with the first aspect, the motive power includes at least one of electric current, voltage, or electric power.

According to this aspect, the value of at least one of electric current, voltage, or electric power to be supplied to the motor (2) is changed into a predetermined value or less in response to seating of the fastening member (X1), thus reducing the chances of causing a kickback.

In an electric tool (1) according to a third aspect, which may be implemented in conjunction with the first or second aspect, the predetermined value is a value of the motive power at the point in time of the seating.

According to this aspect, the value of the motive power to be supplied to the motor (2) is made equal to or less than the value of the motive power at the point in time of seating in response to seating of the fastening member (X1), thus further reducing the chances of causing a kickback.

In an electric tool (1) according to a fourth aspect, which may be implemented in conjunction with any one of the first to third aspects, the driving controller (71) cuts off supply of the motive power to the motor (2) in response to detection of the seating by the seating detector (72).

According to this aspect, the motive power to be supplied to the motor (2) is cut off in response to seating of the fastening member (X1), thus further reducing the chances of causing a kickback.

In an electric tool (1) according to a fifth aspect, which may be implemented in conjunction with any one of the first to fourth aspects, the transmission mechanism (3) includes a clutch mechanism (5). The clutch mechanism (5) switches from a first state where the rotational force is transmitted from the motor (2) to the output shaft (6) to a second state where no rotational force is transmitted from the motor (2) to the output shaft (6), or vice versa.

According to this aspect, revving up in advance the motor (2) in the second state, for example, enables shortening the time it takes to finish fastening the fastening member (X1) since the fastening member (X1) has started to be fastened.

An electric tool (1) according to a sixth aspect, which may be implemented in conjunction with the fifth aspect, further includes an operating unit (trigger 13) and a clutch controller (73). The operating unit accepts an operating command. The clutch controller (73) performs, in accordance with the operating command entered through the operating unit, control of changing a state of the clutch mechanism (5) between the first state and the second state.

According to this aspect, the state of the clutch mechanism (5) may be changed between the first state and the second state in accordance with an operating command entered by a worker, for example.

In an electric tool (1) according to a seventh aspect, which may be implemented in conjunction with the fifth or sixth aspect, the transmission mechanism (3) further includes an inertial body (4). The inertial body (4) is interposed between the clutch mechanism (5) and the motor (2) and increases inertial force of the rotational force of the motor (2).

According to this aspect, interposing the inertial body (4) between the clutch mechanism (5) and the motor (2) may reduce the chances of causing a decrease in the rotational velocity (number of revolutions) when a transition is made from the second state to the first state. This enables, even if the fastening member (X1) is very short, for example, bringing the number of revolutions of the motor (2) that has once decreased while a transition is made from the second state to the first state closer to a predetermined number of revolutions by the time when the fastening member (X1) is seated.

Note that the constituent elements according to the second to seventh aspects are not essential constituent elements for the electric tool (1) but may be omitted as appropriate.

A control method according to an eighth aspect is designed to be used in an electric tool (1) for fastening a fastening member (X1) by using a motor (2) as a power source. The control method includes a detection step, a first control step, and a second control step. The detection step includes detecting seating of the fastening member (X1). The first control step includes controlling the motor (2) to make a number of revolutions of the motor (2) at a point in time of the seating equal to a predetermined number of revolutions associated with a torque setting. The second control step includes changing a value of a motive power to be supplied to the motor (2) into a predetermined value or less in response to detection of the seating in the detection step.

According to this aspect, the number of revolutions of the motor (2) at a point in time of seating of the fastening member (X1) is controlled in the electric tool (1), thus improving the accuracy of the fastening torque irrespective of the length of the fastening member (X1), for example. In addition, the value of a motive power to be supplied to the motor (2) is changed into a predetermined value or less in response to seating of the fastening member (X1) in the electric tool (1), thus reducing the chances of causing a kickback.

A program according to a ninth aspect is designed to cause one or more processors to perform the control method according to the eighth aspect.

According to this aspect, the number of revolutions of the motor (2) at a point in time of seating of the fastening member (X1) is controlled in the electric tool (1), thus improving the accuracy of the fastening torque irrespective of the length of the fastening member (X1), for example. In addition, the value of a motive power to be supplied to the motor (2) is changed into a predetermined value or less in response to seating of the fastening member (X1) in the electric tool (1), thus reducing the chances of causing a kickback.

### REFERENCE SIGNS LIST

1 Electric Tool
11 Tip Tool
13 Trigger (Operating Unit)
2 Motor
3 Transmission Mechanism
4 Inertial Body
5 Clutch Mechanism
6 Output Shaft
71 Driving Controller
72 Seating Detector
73 Clutch Controller
X1 Fastening Member

1. An electric tool comprising:
a motor;
a driving controller configured to control the motor;
an output shaft to be coupled to a tip tool for use to fasten a fastening member;
a transmission mechanism interposed between the motor and the output shaft and configured to transmit rotational force of the motor to the output shaft; and
a seating detector configured to detect seating of the fastening member,
the driving controller is configured to:
control the motor to make a number of revolutions of the motor at a point in time of the seating equal to a predetermined number of revolutions associated with a torque setting; and
change a value of a motive power to be supplied to the motor into a predetermined value or less in response to detection of the seating by the seating detector.

2. The electric tool of claim 1, wherein the motive power includes at least one of electric current, voltage, or electric power.

3. The electric tool of claim 1, wherein
the predetermined value is a value of the motive power at the point in time of the seating.

4. The electric tool of claim 1, wherein
the driving controller is configured to cut off supply of the motive power to the motor in response to detection of the seating by the seating detector.

5. The electric tool of claim 1, wherein
the transmission mechanism includes a clutch mechanism configured to switch from a first state where the rotational force is transmitted from the motor to the output shaft to a second state where no rotational force is transmitted from the motor to the output shaft, or vice versa.

6. The electric tool of claim 5, further comprising:
an operating unit configured to accept an operating command; and
a clutch controller configured to perform, in accordance with the operating command entered through the operating unit, control of changing a state of the clutch mechanism between the first state and the second state.

7. The electric tool of claim 5, wherein
the transmission mechanism further includes an inertial body interposed between the clutch mechanism and the motor and configured to increase inertial force of the rotational force of the motor.

8. A control method for use in an electric tool configured to fasten a fastening member by using a motor as a power source, the control method comprising:
a detection step including detecting seating of the fastening member;
a first control step including controlling the motor to make a number of revolutions of the motor at a point in time of the seating equal to a predetermined number of revolutions associated with a torque setting; and
a second control step including changing a value of a motive power to be supplied to the motor into a predetermined value or less in response to detection of the seating in the detection step.

9. A non-transitory storage medium storing thereon a program designed to cause one or more processors to perform the control method of claim 8.
